(19) United States
(12) Patent Application Publication
(10) Pub. No.: US 2006/0163997 A1
(43) Pub. Date: Jul. 27, 2006

(54) Electron gun having a main lens

(76) Inventors: Ronald Johannes Gelten, Eindhoven (NL); Sebastaien Dorel, Eindhoven (NL)

Correspondence Address: LAHIVE & COCKFIELD, 28 STATE STREET, BOSTON, MA, 02109, US

(21) Appl. No.: 10/540,383

(22) PCT Filed: Dec. 17, 2003
(86) PCT No.: PCT/EP03/14483

§ 371 Date: Feb. 14, 2006

(30) Foreign Application Priority Data
Dec. 30, 2002 (EP) 02080587.5

(51) Int. Cl. H01J 29/50; H01J 29/70

(52) U.S. Cl. 313/428; 313/409

(57) ABSTRACT

An electron gun of the in line type comprises cathodes (2) for emitting electrons, the cathodes being juxtaposed in a first direction. The electron gun comprises a main lens section (4) for focusing the beams of electrons onto a display screen (36). Conventionally, the electrodes (20, 21, 22) of the main lens section comprise a base plate (23), which is a plate shaped element provided with separate apertures for each of the beams. According to the invention, at least one of the electrodes (10, 11, 12) of the main lens section is provided with a so called field cutter (14, 19), which is a plate shaped element provided with a common aperture for all beams. The field cutter allows in preferred embodiments to have astigmatic main lenses that result in better spot performance and a reduced horizontal magnification. Preferably, the main lens has positive dynamic astigmatism, so that a separate DAF section is no longer required.

### TECHNICAL FIELD

The present invention relates to electron guns of the type used in television sets and computer monitors.

### PRIOR ART

Electron guns have a wide use in cathode ray tubes in television sets and computer monitors. A prior art electron gun usually consists of at least a triode for forming electron beams, and a main lens section comprising at least two electrodes. The triode comprises a cathode and two electrodes. A voltage difference is applied between the electrodes of the main lens section, whereby an electric field is defined in the gap between these electrodes. Said electric field accomplishes a focusing lens action on the electron beams, which lens action is such that the electron beams are in focus on the display screen of a cathode ray tube (CRT).

The major trends in CRT development are the strive towards larger screens that are flat or nearly flat, a reduction of the depth of the CRT, a higher resolution and lower cost. From an electronoptical point of view, these trends lead to three issues:

a) For a flat or nearly flat display screen, i.e. a non-spherical display screen, the focal length should vary with the landing position of the electron beams on the display screen. In the corners of the screen, the focal length should be larger than in the center of the screen.

b) The deflection unit is generally a magnetic deflection unit, which has the side effect of also acting as an astigmatic electronoptical lens on the electron beams. The strength of this deflection lens increases with increasing deflection angle, and thus varies with the landing position of the electron beams on the display screen. As a depth reduction generally requires the electron beams to be deflected over a larger angle, the lens action of the deflection lens gets stronger in a CRT with reduced depth.

c) Generally, a viewer perceives an increased sharpness if the spot size, i.e. the size of the electron beam at the display screen, is reduced. This also allows for a higher image resolution.

A simple conventional electron gun has a fixed focal length, which means the electron beams will be focussed well at only one specific distance from the main lens section. For the deflected electron beams in a CRT, this means that the beams are in focus on a spherical surface. The action of the deflection lens is not compensated for.

A more advanced conventional electron gun is the so-called DAF electron gun, which comprises a number of additional electrodes arranged in a Dynamic Astigmatism and Focus (DAF) section. An even more advanced conventional electron gun is the so-called DAF-DBF electron gun, which comprises a DAF section, as well as a Dynamic Beam Forming (DBF) section near the triode.

When a dynamic voltage, i.e. a voltage dependent of the screen position to which the beams are deflected, is applied to at least one of the electrodes in such a DAF section, a dynamic positively astigmatic lens action is provided acting on the electron beam, in order to at least partially compensate for the lens action of the deflection lens. Also, these guns have a variable focal length, so that the focusing of the electron beams on non-spherical surfaces in improved.

The electrodes in conventional DAF and/or DBF sections have to be provided with a high dynamic voltage, so as to form quadrupole lenses that achieve the desired astigmatic lens action. Also, an electron gun with DAF and/or DBF sections is complex as it has a large number of focussing elements. This makes such a gun complicated to construct and thus expensive.

Moreover, due to the distance between the section providing the astigmatic lens action and the main lens section, the spot size of the electron beam on the display screen is relatively large.

### SUMMARY OF THE INVENTION

It is an object of the present invention to provide an electron gun which has a reduced spot size.

It is another object of the present invention to provide a less complicated electron gun which is able to keep the electron beams in focus on a substantial part of a flat or non-flat display screen.

These objects have been achieved by means of an electron gun according to the present invention, as specified in the independent Claim 1.

The direction in which electrons travel inside the electron gun is substantially parallel to the central axis of the gun. The first direction (also to be referred to as horizontal direction or x-direction hereinafter) and the central axis define the so-called ‘in-line plane’, this is the plane in which the electron beams are essentially arranged. The second direction is perpendicular to this in-line plane.

The rim of the electrode may be of similar form as the rim on prior art electrodes, which have the rim bent so that the outer surface is bent around the edge to form the rim. The cross-section diameter of the electrode rim in a direction should be construed as the distance in said direction between portions of the electrode rim opposing each other.

The plate-shaped element being provided with the aperture for passing electrons from all cathodes will be referred to as “field cutter” hereinafter. By virtue of the field cutter, an astigmatic lens action may be provided in the main lens section itself

In a conventional electron gun, the strength of the main lens in the first direction is determined by the position of so-called base plates inside the electrodes of the main lens section. Within the present application, a base plate should be understood to be a plate-shaped element in an electrode of the main lens section, which plate-shaped element is provided with an individual beam-passing aperture for each of the electron beams. The base plate will also be referred to as ‘plate-shaped element of the second type’, whereas the field cutter will also be referred to as ‘plate-shaped element of the first type’.

By putting the base plate deeper into the electrode, i.e. by increasing the distance of the base plate to the gap, the strength of the main lens in the horizontal direction is generally reduced. However, at the same time, putting the base plate deeper into the electrode allows the electric field in the gap to penetrate further into the electrode. This increases the strength of the main lens in the vertical (y-) direction, which is perpendicular to both the horizontal direction and a central axis of the electron gun.

Thus, a decrease of the main lens strength in the horizontal direction leads to an increase of the main lens strength in the vertical direction. It has hitherto been impossible to choose the strengths of the main lens in the horizontal direction and in the vertical direction independently of each other.

The field cutter according to the invention limits the penetration of the electric field in the gap into the electrodes of the main lens section. The electric field penetrates only until the location of the field cutter, and is effectively ‘cut off’ by the latter. This has the effect that the main lens strength in the vertical direction is now determined by the position of the field cutter inside the electrode. The field cutter itself has substantially no effect on the main lens strength in the horizontal direction. However, because of the application of the field cutter, the electric field at the location of the base plate decreases, so that the main lens strength in the horizontal direction is effectively also smaller.

The use of a field cutter in at least one of the electrodes of the main lens section gives an extra degree of freedom in main lens design, since it opens the possibility to optimize the main lens strength in the horizontal and vertical direction independent of each other, and thus introduce a desired astigmatic lens action. The main lens strength in both the horizontal and vertical directions may be set to a desired value, by suitably choosing the position inside the electrode of the field cutter, and the position of the base plate (or more specifically, the distance between the field cutter and the base plate). This allows for the creation of static astigmatism inside the main lens section itself.

Preferably, a distance along the central axis from the gap to the aperture of the field cutter is smaller than the dimension of said aperture in the second direction. Thus, the field cutter is located relatively close to the gap, in which case a relatively high lens strength in the vertical direction is obtained resulting in a relatively high amount of astigmatism. Preferably, the electrode provided with the field cutter does not include a conventional base plate. This allows for an even higher amount of astigmatism to be obtained.

Generally, a main lens comprises a positive lens portion having strength S⁺, which is generally located near an electrode supplied with a lower voltage, and a negative lens portion having strength S⁻, which is generally located near an electrode supplied with a higher voltage. Thus, the total strength S=S⁺+S⁻.

Thus, by providing the higher voltage electrode with a field cutter, one can achieve positive astigmatism, and by providing the lower voltage electrode with a field cutter, one can achieve negative astigmatism. The astigmatic lens action is now provided in the main lens section itself, so that the spot size of the electron beam may be as small as possible.

Furthermore, using the field cutter allows for providing a dynamic positively astigmatic lens action in the main lens section. In this case, a weaker DAF and/or DBF section may be applied in the electron gun, i.e. a DAF and/or DBF section requiring lower dynamic voltages. This is particularly advantageous in electron guns for use in a cathode ray tubes having a large deflection angle, in which the dynamic voltage required for the DAF and/or DBF section in a conventional electron gun would be relatively large.

However, more advantageously and preferably, the invention can be used to provide substantially all required dynamic positively astigmatic lens action in the main lens section, thus allowing the electron gun to be constructed without any DAF and/or DBF section. This results in a significantly simplified electron gun and consequently a relatively large reduction in manufacturing costs.

To achieve positive dynamic astigmatism in the main lens section of the electron gun, the main lens must show a higher relative strength variation in the y-direction than in the x-direction:

$$\frac{Δ {S}_{y}}{{S}_{y}} >> \frac{Δ {S}_{x}}{{S}_{x}} \qquad ( 1 )$$

This condition is easily fulfilled if the total strength of the main lens in the x-direction (Sₓ) is larger than the total strength of the main lens in the y-direction (S_{y}):
Sₓ>>S_{y} (2)

The higher voltage is, in an electron gun for a CRT, usually a fixed anode voltage. When the lower voltage is a dynamic voltage, this has the effect that the main lens becomes weaker because the strength of the positive lens portion is affected more strongly by the changing electric potential than the strength of the negative lens portion. This observation allows the derivation of another condition:
S_{y}⁻>>Sₓ⁻ (3)

Conditions (2) and (3) can easily be met according to the invention.

For this purpose, preferably, the main lens section comprises two electrodes defining, in operation, a bi-potential main lens, wherein the lower voltage electrode is provided with a conventional base plate, and the higher voltage electrode of the main lens section is provided with a field cutter.

More preferably, the higher voltage electrode is not provided with a base plate.

In such an electron gun, the negative lens portion is relatively strong in the y-direction, while the negative lens portion is negligible in the x-direction. Regarding the total main lens strength, in the y-direction the negative and positive lens portions counteract each other, so that the total lens action in the y-direction is relatively small. At the same time, the main lens strength in the x-direction is essentially determined by the relatively strong positive lens portion.

The main lens section may now have a dynamic positively astigmatic lens action if the lower voltage is a dynamic voltage. The main lens takes over the lens action of a DAF and/or DBF section partially or in full. Thereby, the electron gun enables an electron beam to be in focus on the display screen particularly well, while using a smaller number of elements in the electron gun. An electron gun with such a main lens section may have a large dynamic astigmatism even without employing a DAF or DBF section,

More preferably, the main lens section is of the DCFL type and comprises three electrodes, namely an electrode receiving a lower voltage, an intermediate electrode receiving an intermediate voltage and an electrode receiving a higher voltage. The latter electrode is usually called anode, and the higher voltage is the anode voltage. The intermediate voltage is generally obtained from the anode voltage by means of a resistive divider (bleeder). The lower voltage supplied to the focus electrode is preferably a dynamic voltage.

In this case, the (focus) electrode receiving a lower voltage is provided with a field cutter, the intermediate electrode is provided with a conventional base plate, and the anode is provided with a field cutter. Preferably, the electrode receiving the lower voltage and the anode do not include a conventional base plate.

Such a DCFL lens meets conditions (2) and (3). The advantage that this lens type has, is that such a DCFL lens formed by a main lens section of at least three electrodes achieves an amount of positive dynamic astigmatism substantially larger than a main lens formed by a main lens section of two electrodes. The dynamic astigmatism is for example increased by a factor of 4.

The preferred embodiments set out in the above have an additional advantageous property. The magnification factor in the horizontal direction, indicated by Mₓ, of the main lens sections of the preferred embodiments is low as compared to prior art designs.

It is assumed that the electron-optical thickness of the main lens in the horizontal direction is reduced, because the lens action in the horizontal direction in the electrodes provided with a field cutter is negligible. For example, in the DCFL lens preferred embodiment, the main lens action in the horizontal direction is substantially achieved by the base plate in the intermediate electrode only, whereas in a prior art DCFL lens the main lens action is divided over the three electrodes. The reduced electron-optical thickness of the main lens in the horizontal direction leads to a smaller horizontal magnification factor Mₓ.

For example, the horizontal magnification factor in a DCFL lens is reduced by 5%, while the object distance (distance between cathodes and main lens) is simultaneously reduced by 7 millimeters. Thus, the preferred embodiments allow construction of a shorter electron gun with a smaller horizontal magnification, resulting in smaller spot sizes of the electron beam of the display screen.

In an electron gun according to the invention, the electric field in the main lens section the electric field is asymmetric between the base plate and the end of the electrode. This may results in lens distortions for the electron beams that are not in the center of the lens but closer to the edge, i.e. the outer electron beams in the in-line plane. Consequently, these beams that are closer to the edge of the electrode experience a different lens action while traversing through the main lens section, an effect we term “mis-alignment” between the lenses for the three beams.

According to a preferred embodiment of the present invention, the base plate is provided with a barrel-shaped aperture.

Within this application, a barrel-shaped aperture should be construed as an aperture that essentially has no straight edges, but bent edges. In particular, the aperture edges parallel to the in-line plane curve outwardly with respect to the in-line plane. The barrel-shaped aperture allows for correction of the mis-alignment of the lenses for the different electron beams.

Preferably, the horizontal extension of the aperture in the field cutter is at least 75% of the distance between opposing rim portions (i.e. the cross-section diameter) in the horizontal direction.

Preferably, the vertical extension of the aperture in the field cutter is at least 25% of the distance between opposing rim portions (i.e. the cross-section diameter) in the vertical direction.

It goes without saying that the different aspects of the invention may be combined in the same embodiment.

In the following different embodiments of the invention will be described with reference to the drawings. In the description of preferred embodiments similar features are denoted by the same reference numerals.

### SHORT DESCRIPTION OF THE DRAWINGS

FIG. 1 shows a simple electron gun according to the prior art.

FIG. 2a shows an electron gun according to the prior art.

FIG. 2b shows an electron gun according to the present invention.

FIG. 3a-c shows a main lens section with three electrodes according to the prior art.

FIG. 4 shows an embodiment of a main lens section according to the present invention.

FIG. 5 shows a prior art CRT.

FIG. 6a-b shows another embodiment of a main lens section in an electron gun according to the present invention.

FIG. 7 shows a field cutter in an electron gun according to a preferred embodiment of the present invention.

### DESCRIPTION OF PREFERRED EMBODIMENTS

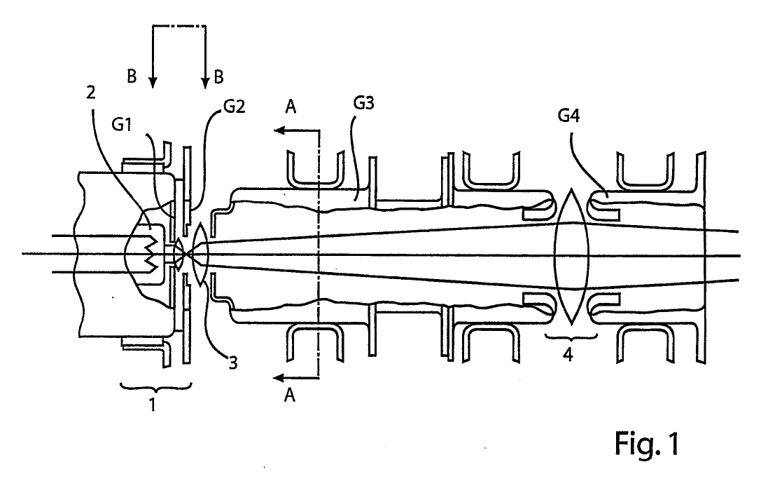

A simple electron gun according to the prior art is shown in FIG. 1. The main regions of the electron gun are: triode 1 (i.e. a cathode 2 and two electrodes, G1, G2), pre-focus lens 3 (i.e. the field between G2 and a third electrode G3), and main lens section 4 (i.e. the field between the third electrode G3 and a fourth electrode, G4). More complicated guns include a Dynamic Astigmatism and Focus (DAF) section, and a Dynamic Beam Forming (DBF) region. For the discussion that will follow, it is important to note the following:

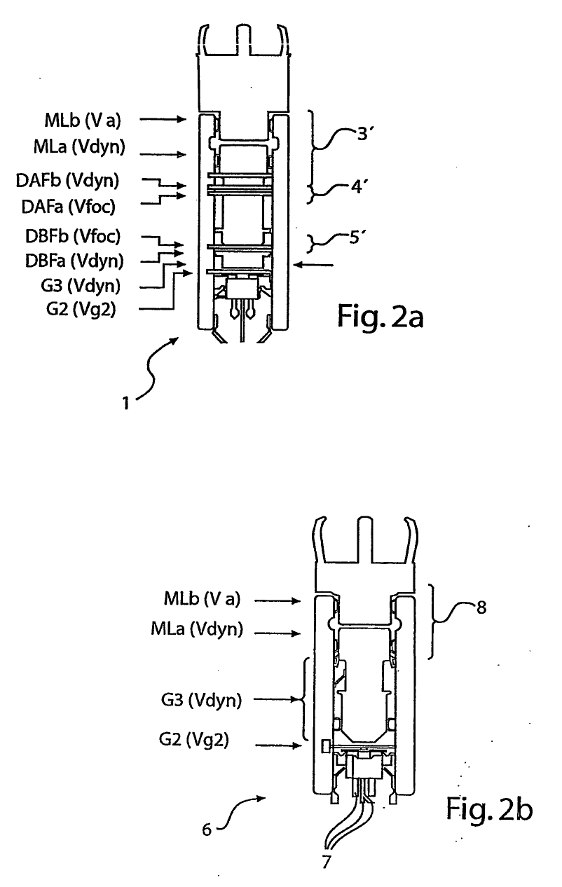

A simple electron gun as illustrated in FIG. 1 has a fixed focus length, which means the electron beams will be focussed well at only one specific distance from the main lens section 4. For the deflected electron beams in a CRT, this means that the beams are focused on a spherical surface. As the distance of the screen to the main lens section 4 varies with the position on the screen, the electron beams will not be in focus on every screen position. DAF and DBF sections correct for this by providing dynamic lenses in the gun to adapt the focus length depending on the screen position. This is achieved by supplying a dynamic control voltage Vdyn, i.e. a voltage that changes with the screen position to which the electron beams are deflected, to at least one of the electrodes in the DAF and DBF section. Such a DAF-DBF gun is illustrated in FIG. 2a.

In the triode, there are essentially three voltage levels, the voltage of G1, Vg1, the voltage of G2, Vg2, and the voltage of the cathode 2, Vcathode.

By controlling the cathode potential (Vcathode) the field between the cathode and electrode G1 is controlled. The flat cathode 2 emits electrons and by placing G1 at a lower potential than the cathode 2, the electrons are prevented from landing on G1. The apertures in the G1 electrode through which the electrons travel limit the influence of the Vg2 voltage in spatial extension and magnitude. A high positive potential at G2 accelerates the electrons.

In most electron guns, Vg2 and Vg1 are fixed, typically at around Vg2=700 V to 1100 V and Vg1=0 V. Vcathode is varied to modulate the beam current; at higher cathode voltage, fewer electrons are pulled into the beam by G2 and at lower cathode voltage, more electrons are pulled into the beam. Typically, Vcathode varies between 0 V and 200 V.

In FIG. 2a an electron gun 1 according to prior art is shown. The electron gun has three cathodes corresponding to the three colors to be displayed on the screen for which the electron gun is used. The electron gun has contacts to the triode electrodes G1 and G2 to which the voltages Vg1 and Vg2 are applied. The electron gun 1 has a main lens section consisting of two electrodes 3′. These electrodes will be shown in greater detail in FIG. 2c. A DAF lens 4′ and a DBF lens 5′ are arranged between the cathodes 2 and the main lens section 4. A large number of voltage contacts DBFa, DBFb, DAFa, DAFb, MLa and MLb are present on which contacts voltages Vfoc, Vdyn and Va are applied. In the figure Vfoc denotes a static focussing voltage while Vdyn denotes a dynamic control voltage.

If the object of the invention of having large dynamic astigmatism in the main lens section is exploited, the variable focus length that is characteristic of DAF-DBF guns, as explained in the above, can be achieved with the mechanical simplicity of a gun such as depicted in FIG. 2b, differing from FIG. 1 in that the static focus voltage Vfoc is now replaced by a dynamic control voltage Vdyn. As is evident from FIGS. 2a and 2b the embodiment shown in FIG. 2b has less parts and is thus less complicated and less expensive to produce. The electron gun 6 shown in FIG. 2b has a main lens section 8. Also shown in FIG. 2b are the contacts for the cathode.

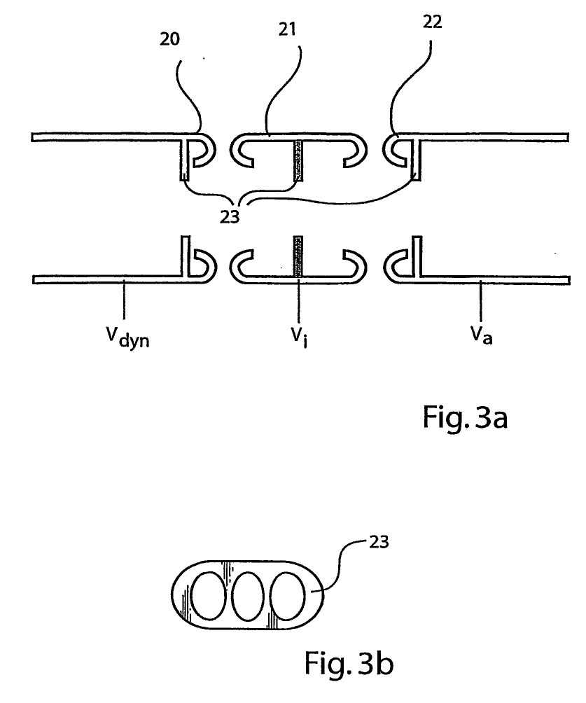

A main lens section according to the prior art is shown in FIG. 3. The main lens section comprises a focus electrode 20, an intermediate electrode 21 and an anode electrode 22. A base plate 23 is arranged in each one of the electrodes. The plate defines three holes through which the electrons are arranged to pass. The focus electrode, the intermediate electrode and the anode electrode are coupled to the voltages V_{dyn}, Vᵢ and Vₐ, respectively.

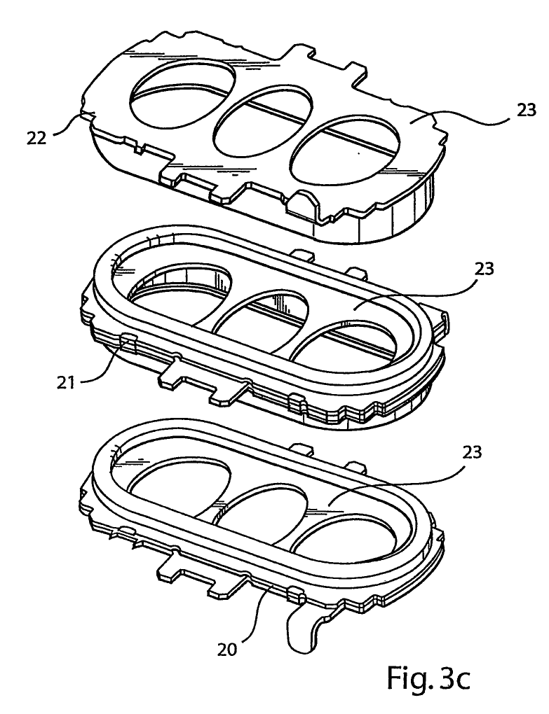

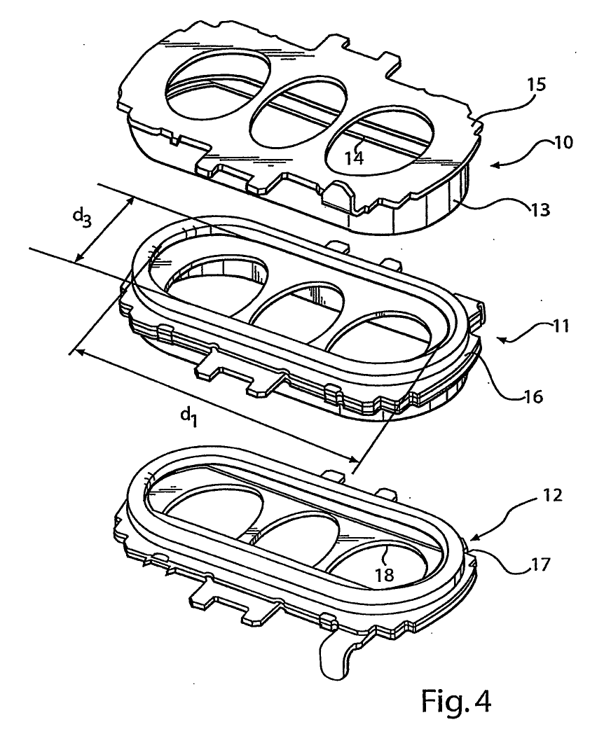

In FIG. 4 a main lens section according to an embodiment of the invention is shown. The main lens section comprises a first electrode 10, a second electrode 11 and a third electrode 12. The first electrode has a first jacket 13 in which a field cutter 14, i.e. a plate of the first type, is integrated and a first base plate 15, i.e. a plate of the second type, which is attached to the first jacket, said base plate having three holes corresponding to the three electron beams from the cathodes. The three beams lying in the in-line plane are indicated in FIG. 5.

The second electrode 11 has a similar second base plate 16 which is attached to a second jacket. The third electrode 12 has a third jacket 17 and a similar third base plate 17 attached to the jacket and a second field cutter 19 which is integral with the jacket.

The distance between opposing portions of the electrode rim in the first direction is denoted by d₁, this is the cross-section diameter in the first direction. The second direction is the direction perpendicular to the in-line plane. The distance between opposing portions of the electrode rim in the second direction is denoted by d₂, this is the cross-section diameter in the second direction.

Preferably the extension in the first direction of the aperture in the field cutter is at least 75% of d₁ in this direction. Obviously, the aperture cannot extend beyond the electrode itself The extension of the field cutters in the second direction is preferably between 25% and 100% of d₃, and most preferred between 40% and 60% of d₃. The field cutters, i.e. plates of the first type, improve the performance of the electron gun in terms of spot size (resolution on the screen).

FIG. 5 shows schematically a cathode ray tube (CRT) according to an embodiment of the invention. The CRT comprises an electron gun 30, and deflection means 33 and 34, which may be electromagnets. The deflection means are usually integrated in one unit.

The CRT also comprises a shadow mask 35 in front of a luminescent screen 36. All these parts are contained within a vacuum tube 37. The three electron beams corresponding to the three colors on the screen are represented by the dotted lines 31, 32, 38. The spot size on the screen is dependent on the position on the screen. It is easier to provide a small spot on the center of the screen than on the periphery of the screen. Thus, the primary goal is to minimize the spot size in the periphery of the screen.

In operation electrons are emitted from the cathodes with help from the electrodes in the triode and voltages thereon. The electrons are then accelerated and focussed by the focussing system to a focussed electron beam. The focussed electron beam is then deflected by the deflection means. The electrons are finally spatially filtered by the shadow mask, so that after filtration they hit the luminescent screen.

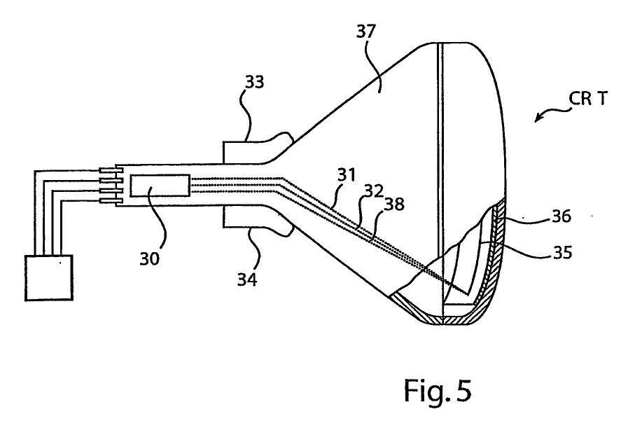

An alternative embodiment of the invention is shown in FIG. 6. The main lens section 40 shown in FIG. 6 only has two electrodes namely the focus electrode 41, which has a plate 42 of the first type, and an anode electrode 43, which has a plate 44 of the second type defining only one hole. A dynamic control voltage V_{dyn} and an anode voltage Vₐ are arranged to be applied to the focus electrode and the anode electrode, respectively. The anode voltage is typically 25 kV to 35 kV depending on the type of display (e.g. television or computer monitor). In electrodes such as electrode 43 in FIG. 6a, where no base plate is present, the field cutter is characterized in that it has a single aperture with the dimensions as stated above and in that the depth d₃, i.e. the distance from the plate of the second type to the gap between the electrodes, is not larger than the cross-sectional diameter d₂ of the electrode rim

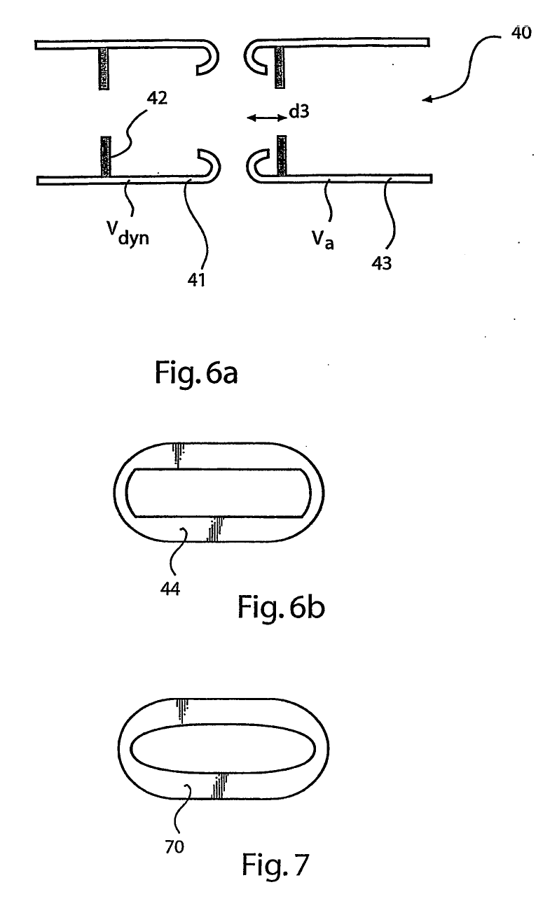

FIG. 7 shows an embodiment of a field cutter 70 wherein the hole is barrel shaped. By having the hole barrel shaped the asymmetry in the electric field is at least partially compensated for. When sides of the hole in the field cutter deviate from straight lines, the dimension of the hole is taken at the position where the dimension is maximal.

The embodiments described above are only described in order to enable a person skilled in the art to practice the invention and may be modified in many ways without departing from the scope and spirit of the invention, which is defined by the accompanying claims.

In summary, an electron gun of the in-line type comprises cathodes for emitting electrons, the cathodes being juxtaposed in a first direction. The electron gun comprises a main lens section for focusing the beams of electrons onto a display screen, preferably the display screen of a cathode ray tube.

Conventionally, the electrodes of the main lens section comprise a base plate, which is a plate-shaped element provided with separate apertures for each of the beams. According to the invention, at least one of the electrodes of the main lens section is provided with a so-called field cutter, which is a plate-shaped element provided with a common aperture for all beams. The field cutter allows in preferred embodiments to have astigmatic main lenses that result in better spot performance and a reduced horizontal magnification. Preferably, the main lens has positive dynamic astigmatism, so that a separate DAF section is no longer required.

1. An electron gun of the in-line type, comprising;
cathodes for emitting electrons, which said cathodes are juxtaposed in a first direction, and
a main lens section comprising at least two electrodes, whereby a gap is provided between adjacent ones of the electrodes, and a gap-facing end of at least one of the electrodes comprising an electrode rim, characterized in that at least a selected one of the electrodes comprises a plate-shaped element arranged inside the selected electrode, said element being provided with a common aperture for passing electrons from each cathode, a dimension of said aperture to a second direction being smaller than a cross-section diameter of said rim in the second direction, the second direction being perpendicular to both the first direction and a central axis of the electron gun.

2. An electron gun according to claim 1, wherein, for said at least one of the electrodes, a distance along the central axis from the gap to the plate-shaped element is smaller than the dimension of said aperture in the second direction.

3. An electron gun according to claim 1, wherein the electrodes of the mate lens section each comprise at least one plate-shaped element arranged on the inside of the electrode, said plate-shaped element being one of
a first type of plate-shaped element being provided with a common aperture for passing electrons from each cathode, and
a second type of plate-shaped element being provided with a number of apertures, each aperture corresponding to a cathode for passing electrons from said cathode only,
wherein said plate-shaped element in said at least one of the electrodes is a plate-shaped element of the first type.

4. An electron gun according to claim 3, wherein the main lens section comprises two electrodes defining, in operation, a bi-potential main lens,
wherein an electrode receiving a lower voltage (Vdyn) is provided with a plate-shaped element of the second type, and an electrode receiving a higher voltage (Va) is provided with a plate-shaped element of the first type.

5. An electron gun according to claim 3, wherein the main lens section comprises three electrodes defining, in operation, a Dynamic Composes Field Lens (DCFL)-type main lens,
wherein an electrode receiving a lower voltage (Vdyn) is provided with a plate-shaped element of the first type,
an electrode receiving an intermediate voltage (Vi) is provided with a plate-shaped element of the second type, and
an electrode receiving a higher voltage (Va) is provided with a plate-shaped element of the first type.

6. An electron gun according to claim 4, wherein an electrode provided with a plate-shaped element of the first type does not include a plate-shaped element of the second type.

7. An electron gun according to claim 1, wherein the aperture in the plate-shaped element of said at least one of the electrodes is barrel-shaped.

8. An electron gun according to claim 3, wherein the aperture in the plate-shaped element of the first type is barrel-shaped.

9. An electron gun according to claim 1, wherein a dimension of the aperture in the first direction is at least 75% of a cross-section diameter of the electrode rim in the first direction.

10. An electron gun according to claim 1, wherein a dimension of the aperture in the second direction is at least 25% of a largest cross-section diameter of the electrode rim in the second direction.
